(19) United States
(12) Patent Application Publication
(10) Pub. No.: US 2011/0061405 A1
(43) Pub. Date: Mar. 17, 2011

(54) VEHICULAR AIR CONDITIONER EQUIPPED WITH VEHICLE SHUTTER DEVICE, AND FAILURE DETERMINING METHOD FOR VEHICLE SHUTTER DEVICE

(75) Inventors: Shogo WATANABE, Utsunomiya-shi (JP); Masashi OGAWA, Utsunomiya-shi (JP); Takumi SAITO, Shioya-gun (JP); Choji SAKUMA, Utsunomiya-shi (JP); Yoshitaka SAIDA, Utsunomiya-shi (JP); Isao TSUNODA, Utsunomiya-shi (JP); Hironori SHUTO, Sakura-shi (JP); Yasuo MINAKAWA, Utsunomiya-shi (JP)

(73) Assignees: KEIHIN CORPORATION, Tokyo (JP); HONDA MOTOR CO., LTD., Tokyo (JP)

(21) Appl. No.: 12/883,641

(22) Filed: Sep. 16, 2010

(30) Foreign Application Priority Data
Sep. 16, 2009 (JP) 2009-214202
Sep. 16, 2009 (JP) 2009-214203
Sep. 16, 2009 (JP) 2009-214207

(51) Int. Cl. B60H 1/32; F25B 1/00; F25D 17/04

(52) U.S. Cl. 62/61; 62/498; 62/408; 62/133

(57) ABSTRACT

A vehicular air conditioner includes cabin-exterior fans that blow air with respect to a cabin-exterior heat exchanger in which a coolant is vaporized, and a plurality of openable/closable shutters disposed in a duct that communicates between the cabin-exterior heat exchanger and the exterior of the vehicle. On an upper portion of the duct, a cover is formed that covers the cabin-exterior heat exchanger, which is disposed rearwardly of the shutters, and an upper region of the radiator. Additionally, air that is raised in temperature by heat from the engine passes between the cover and both the cabin-exterior heat exchanger and the radiator, and is guided toward a forward side of the vehicle.

### CROSS-REFERENCE TO RELATED APPLICATION

This application is based upon and claims the benefit of priority from Japanese Patent Applications No. 2009-214202 filed on Sep. 16, 2009, No. 2009-214203 filed on Sep. 16, 2009, and No. 2009-214207 filed on Sep. 16, 2009, of which the contents are incorporated herein by reference.

### BACKGROUND OF THE INVENTION

1. Field of the Invention

The present invention relates to a vehicular air conditioner having both cooling and heating functions, the air conditioner being equipped with a vehicle shutter device for switching an introduction state of external air into an engine room of the vehicle. The present invention also concerns a failure determining method for such a vehicle shutter device.

2. Description of the Related Art

The present applicants, as disclosed in Japanese Laid-Open Patent Publication No. 2003-170733, have proposed a vehicular air conditioner, which is capable of carrying out a cooling operation for supplying chilled air into a vehicle compartment by switching a flow direction of a coolant, as well as a heating operation for supplying warm air into the vehicle compartment.

The vehicular air conditioner is equipped with a shutter, which is capable of switching a communication state between an engine room of the vehicle and the exterior. In the case that the exterior air temperature is low, by blocking access to the engine room through operation of the shutter, escape of air that has been warmed by the engine inside the engine room is prevented, and such warm air can suitably be supplied into the vehicle compartment. Together therewith, in the case that the exterior air temperature is high, the shutter may be set in an opened state, whereby the exterior air can be supplied into the engine room.

### SUMMARY OF THE INVENTION

A general object of the present invention is to provide a vehicular air conditioner equipped with a vehicle shutter device and a failure determining method therefor, in which a heat exchanger can efficiently collect heat generated by the engine, and which can further improve a heating capability of the air conditioner. Together therewith, with a simple structure, opened and closed states of an openable/closable door can reliably be detected, and a failure state of the openable/closable door can reliably be confirmed.

A further object of the present invention is to provide a vehicular air conditioner equipped with a vehicle shutter device comprising a heat exchanger, which is capable of reducing pressure losses when a coolant flows through the heat exchanger and heat exchange is performed, and further which enables the coolant to flow through the heat exchanger at a desired pressure for stably carrying out heat exchange.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an overall schematic view of a vehicular air conditioner equipped with a vehicle shutter device according to an embodiment of the present invention;

FIG. 2 is an outline perspective view showing a circulation state of air between a radiator and a cabin-exterior heat exchanger in the vehicular air conditioner of FIG. 1;

FIG. 3 is an enlarged side view in the vicinity of shutters in the vehicular air conditioner of FIG. 1;

FIG. 4 is an exterior perspective view showing a cabin-exterior heat exchanger in the vehicular air conditioner of FIG. 1;

FIG. 5 is a characteristic curve diagram showing a relationship between the flow passage diameter of a second port and pressure loss when a heating operation of the cabin-exterior heat exchanger shown in FIG. 4 is performed;

FIG. 6 is an enlarged perspective view with partial omission showing an opened state of the shutters of FIG. 3;

FIG. 7 is an enlarged perspective view with partial omission showing a closed state of the shutters of FIG. 6;

FIG. 8 is an enlarged side view showing a closed state of the shutters of FIG. 3;

FIG. 9 is an outline plan view showing flow of air during a closed state of the shutters of FIG. 8;

FIG. 10 is a structural diagram of an air conditioning circuit showing in outline heating operations of the vehicular air conditioner of FIG. 1;

FIG. 11 is a structural diagram of the air conditioning circuit of FIG. 10, showing in outline cooling operations thereof;

FIG. 12 is an enlarged side view showing a vehicular air conditioner according to a first modified example, in which an upper portion of the radiator extends to a duct;

FIG. 13 is an outline plan view showing a vehicular air conditioner according to a second modified example, to which shutters are applied, the width dimension of which is set greater than the width dimension of the radiator;

FIG. 14 is an outline plan view showing a vehicular air conditioner according to a third modified example, in which shutters and support shafts supporting the shutters are disposed in a vertical direction;

FIG. 15A is a comparison diagram showing a relationship between pressure loss in a conventional heat exchanger and a heat exchanger of the present invention during a time when heating operations are performed;

FIG. 15B is a comparison diagram showing a relationship between pressure loss in a conventional heat exchanger and a heat exchanger of the present invention during a time when cooling operations are performed;

FIG. 16 is a flowchart showing operations when a failure determining process of the vehicle shutter device is carried out;

FIG. 17 is a characteristic curve diagram showing a relationship between voltage of a cabin-exterior fan and vehicle velocity; and

FIG. 18 is a characteristic curve diagram showing relationships between vehicle velocity, opened and closed states of the vehicle shutter device, voltage of the cabin-exterior fan, and time.

### DESCRIPTION OF THE PREFERRED EMBODIMENTS

A preferred embodiment of a vehicular air conditioner equipped with a vehicle shutter device according to the present invention shall be described below with reference to the drawings.

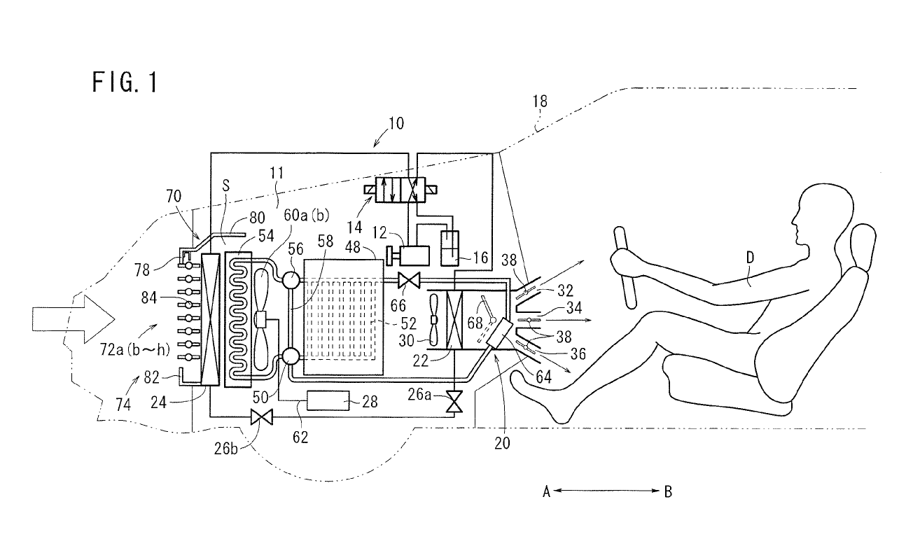

In FIG. 1, reference numeral 10 indicates a vehicular air conditioner equipped with a vehicle shutter device according to the present invention.

As shown in FIGS. 1 through 3, the vehicular air conditioner 10 includes, in an engine room 11, a compressor 12 that draws in and compresses a coolant, a four-way valve 14 for controlling a supply direction of the coolant, an accumulator 16 disposed in a passage through which the coolant flows from the four-way valve 14 toward the compressor 12, a cabin-interior heat exchanger 22 disposed inside a unit 20 that communicates with the interior of the vehicle 18, a cabin-exterior heat exchanger 24 disposed in a front portion of the vehicle 18, first and second solenoid valves 26a, 26b arranged between the cabin-interior heat exchanger 22 and the cabin-exterior heat exchanger 24 and which are cable of adjusting a degree of opening therebetween, and a controller 28, which controls the compressor 12, the first and second solenoid valves 26a, 26b, etc.

A cabin-interior fan 30 is disposed adjacent to the cabin-interior heat exchanger 22. Further, on the cabin-interior side of the unit 20, there are provided respectively a defroster outlet port 32, a face outlet port 34 and a foot outlet port 36, each of the outlet ports 32, 34, 36 being openable and closable by means of dampers 38.

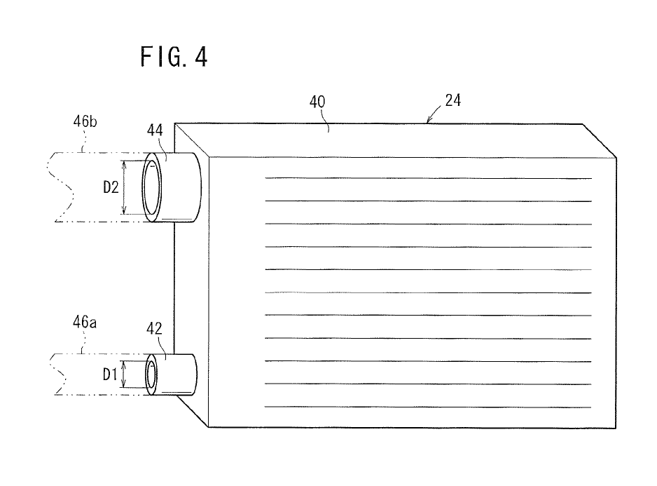

Further, as shown in FIG. 4, the cabin-exterior heat exchanger 24 includes a main body (housing) 40 having passages in the interior thereof through which the coolant flows, a first port (first passage) 42 through which the coolant is introduced into the main body 40, for example, when a heating operation is carried out, and a second port (second passage) 44 through which the coolant that was introduced from the first port 42 and having passed through the interior of the main body 40 is discharged to the exterior. For example, during a cooling operation, and under a switching action of the four-way valve 14, the first port 42 may also function as an outlet side port through which the coolant having passed through the interior of the first port 42 is discharged, whereas conversely, the second port 44 may function as an inlet side port through which the coolant is introduced into the main body 40.

The first and second ports 42, 44, for example, are disposed on one side surface of the main body 40, being separated a predetermined distance from each other, and are formed as pipes that project from the side surface. In addition, pipes or hoses (first passage, second passage) 46a, 46b through which the coolant flows are connected respectively to the first and second ports 42, 44.

The passage diameter (inner diameter) D2 of the second port 44 is set within a range that exceeds 10 mm and is less than or equal to 14 mm (10 mm<D2≦14 mm), for example, in the case that the passage diameter D1 of the first port 42 is set at 5 mm. Stated otherwise, the passage diameter D2 of the second port 44 is set to a size that exceeds roughly two times, and is less than or equal to roughly 2.8 times, the passage diameter (inner diameter) D1 of the first port 42 (2×D1<D2≦2.8×D1).

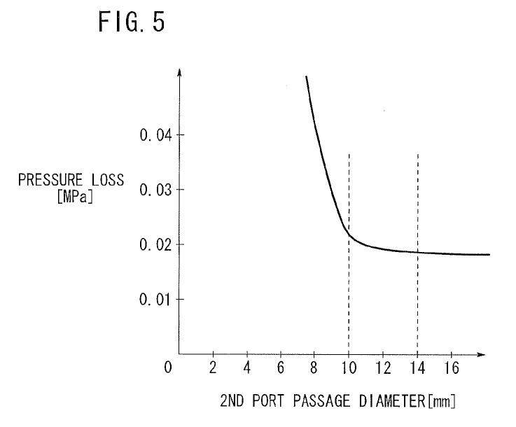

The passage diameter D2 of the second port 44 is set based on a change in pressure loss that occurs at the second port 44 during a heating operation, details of which shall be explained briefly with reference to FIG. 5. FIG. 5 is a characteristic curve diagram showing changes in pressure loss generated at the second port 44 during a heating operation of the vehicular air conditioner 10, in the case that the passage diameter D1 of the first port 42 in the cabin-exterior heat exchanger 24 is set, for example, at 5 mm, and the passage diameter D2 of the second port 44 varies.

As understood from FIG. 5, the relationship between pressure loss and the passage diameter D2 of the second port 44 indicates that, as the passage diameter D2 of the second port 44 becomes greater, the pressure loss gradually decreases. More specifically, since it can be understood that from a point at which the passage diameter D2 of the second port 44 exceeds roughly 10 mm, the rate of change in the pressure loss becomes small, preferably, the passage diameter D2 is set to exceed 10 mm, or more specifically, to exceed roughly two times the passage diameter D1 of the first port 42.

Stated otherwise, since it can be seen that the pressure loss increases rapidly when the passage diameter D2 of the second port 44 becomes less than or equal to 10 mm (D2≦10 mm), it is not desirable to set the passage diameter D2 to reside within such a range.

Further, since it also can be understood that, from a point at which the passage diameter D2 is set in the vicinity of roughly 14 mm, the rate of change in the pressure loss becomes small, preferably, the passage diameter D2 is set less than or equal to 14 mm, or more specifically, is set to be less than or equal to roughly 2.8 times the passage diameter D1 of the first port 42. Even in the case that the passage diameter D2 exceeds 14 mm, since as shown in FIG. 5, the pressure loss as well as the rate of change in the pressure loss remains small, the passage diameter D2 may be set within this range if desired.

The engine 48 of the vehicle 18 is equipped with a water jacket 52 into which cooling water, which flows under operation of a water pump 50, is supplied. A radiator 54, which is disposed adjacent to the cabin exterior heat exchanger 24, is connected via a thermostat 56 to the water jacket 52. The thermostat 56 and the water pump 50 are interconnected via a bypass passage 58.

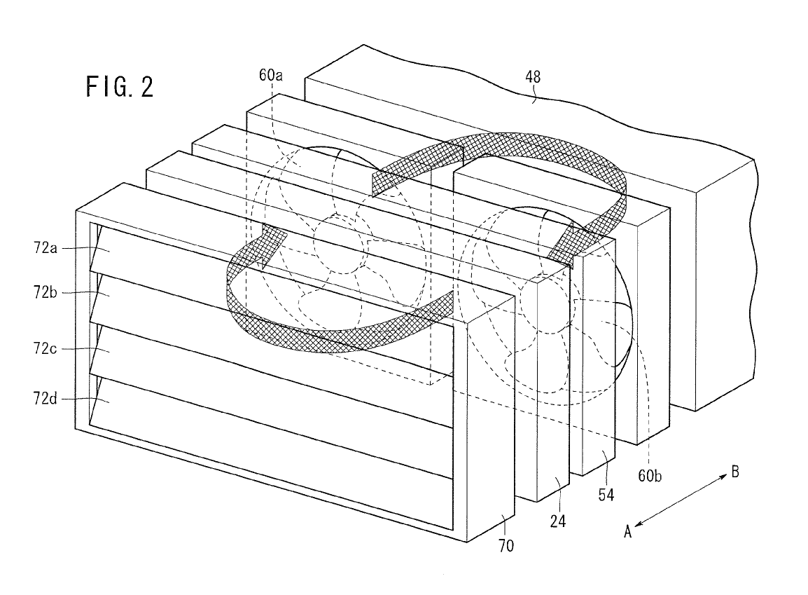

As shown in FIGS. 1 and 2, a pair of cabin-exterior fans (blower fans) 60a, 60b is disposed adjacent to the radiator 54. The cabin-exterior fans 60a, 60b are connected respectively to the controller 28 via lead lines 62 and are controlled under operation of the controller 28. Further, in a non-driven state, when control signals from the controller 28 are not input thereto, the cabin-exterior fans 60a, 60b are disposed in an idle or freely rotatable state (i.e., can be rotated by running wind blowing therethrough).

A heater core 64 that is arranged in the unit 20 is connected to the water jacket 52 via a water valve 66. A damper 68 for blocking the heater core 64 from the cabin-interior heat exchanger 22 is disposed between the cabin-interior heat exchanger 22 and the heater core 64.

On the other hand, a duct 70 is provided to serve as a communication passage that communicates between the cabin-exterior heat exchanger 24 and the radiator 54 and the exterior of the vehicle 18. A vehicle shutter device 74 having a plurality of shutters (openable/closable doors) 72a to 72h for opening and closing the duct 70 is disposed in the duct (communication passage) 70. The shutters 72a to 72h are disposed in parallel along the height direction of the vehicle 18.

More specifically, in the vehicular air conditioner 10, the shutters 72a to 72h, the cabin exterior heat exchanger 24 and the radiator 54 are arranged in series from a forward side (in the direction of the arrow A) toward the rearward side (in the direction of the arrow B) of the vehicle 18, while the engine 48 is disposed rearwardly of the radiator 54.

The duct 70, for example, is formed from plates having a fixed thickness, and comprises an opening 76 with a rectangle-shaped cross section in the center thereof in which shafts are arranged. On an upper portion of the opening 76, an upper end wall 78 is formed that extends in a vertical upward direction. The duct 70 is bent from an edge of the upper end wall 78 toward the rearward side (in the direction of the arrow B) of the vehicle 18, thereby forming a cover 80 that extends substantially horizontally for a predetermined length. In greater detail, on the upper portion of the duct 70, the cover 80 extends from the upper part of the shutter 72a in a rearward direction (the direction of the arrow B) of the vehicle 18, the cover 80 being formed so as to cover the region above the radiator 54.

In other words, the upper end wall 78 of the duct 70 is arranged in the vicinity of the uppermost disposed shutter 72a, such that when the shutters 72a to 72h are in an opened condition, one end portion of the shutter 72a abuts against the upper end wall 78.

Further, the upper portion of the duct 70 is separated a predetermined distance from the top of the cabin-exterior heat exchanger 24 and the radiator 54, thereby forming a gap S between the duct 70 and both the cabin-exterior heat exchanger 24 and the radiator 54.

The cover 80 is not limited to a case of extending over the upper region of the radiator 54, and for example, may extend to a position that covers a portion of the engine 48, which is disposed more rearwardly than the radiator 54.

On the other hand, at the lower portion of the opening 76 in the duct 70, a lower end wall 82 is formed that extends vertically downward, at which point the duct 70 is bent perpendicularly in a rearward direction (the direction of the arrow B) of the vehicle 18 from the end portion of the lower end wall 82, and extends to a position in abutment with the side surface of the cabin-exterior heat exchanger 24. More specifically, because the lower portion of the duct 70 abuts against the side wall of the cabin-exterior heat exchanger 24 via the lower end wall 82, leakage of air is prevented from occurring between the lower end wall 82 and the cabin-exterior heat exchanger 24.

Stated otherwise, the lower end wall 82 of the duct 70 functions as a seal, which is cable of preventing leakage of air from occurring between the lower portion of the duct 70 and the cabin-exterior heat exchanger 24.

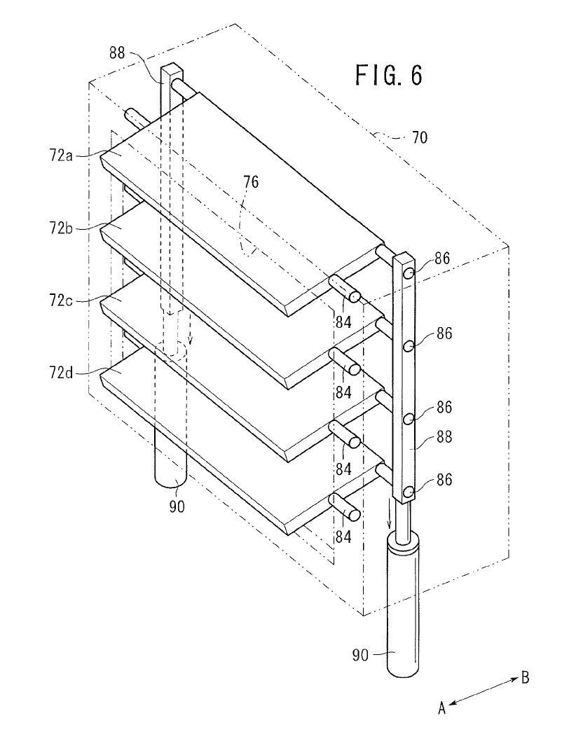

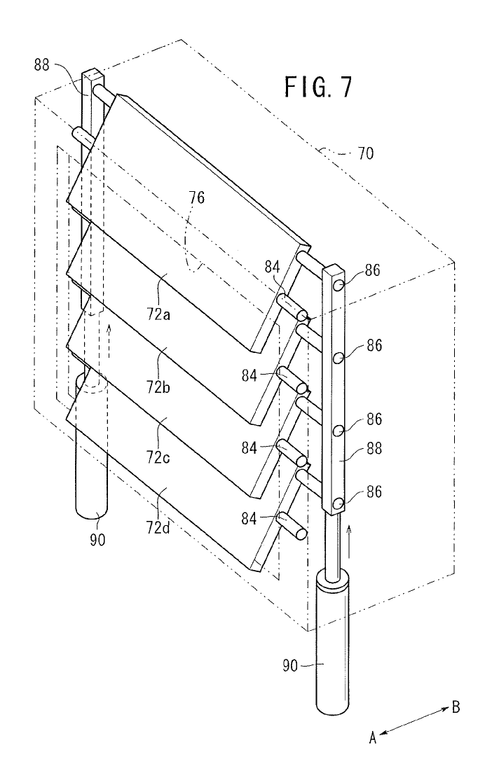

As shown in FIGS. 6 and 7, the shutters 72a to 72h are rotatably disposed in the duct 70 via support shafts 84 on opposite sides thereof, and further, are supported substantially in parallel with each other while being separated mutually by predetermined distances.

Additionally, shafts 86, which are formed at end portions of the shutters 72a to 72h offset from the substantially horizontally disposed support shafts 84, are supported axially on displacement members 88, which are arranged at opposite sides of the duct 70.

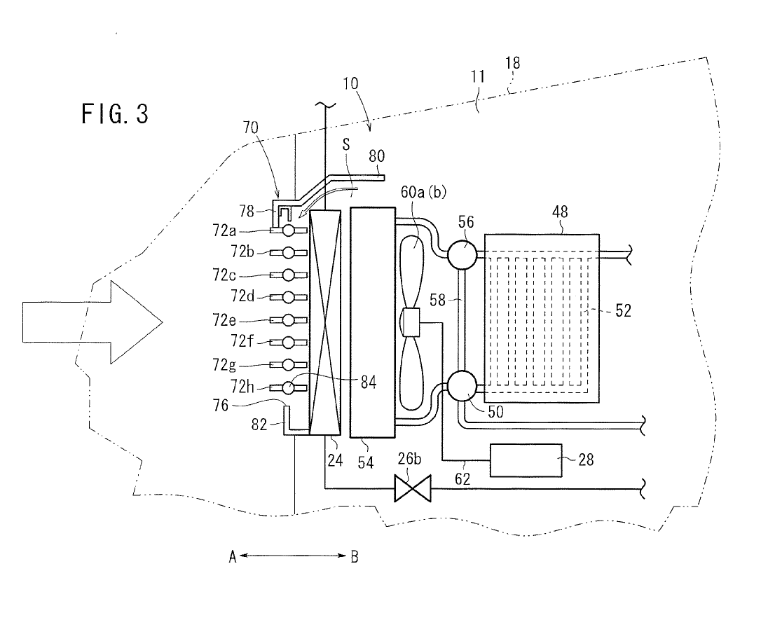

Additionally, as shown in FIGS. 3 and 6, in an opened condition (OPEN) when the shutters 72a to 72h are disposed substantially horizontally about the support shafts 84, one end of the uppermost shutter 72a on the forward side (the direction of the arrow A) of the vehicle 18 is disposed in abutment against the upper end wall 78 of the duct, whereas one end of the lower most shutter 72h on the forward side (the direction of the arrow A) of the vehicle 18 is disposed out of contact with the lower end wall 82 of the duct 70.

Further, when the shutters 72a to 72h are in an opened state, the other ends of the shutters 72a to 72h facing the rearward side (in the direction of the arrow B) of the vehicle 18 are disposed in close proximity to a side surface of the cabin-exterior heat exchanger 24.

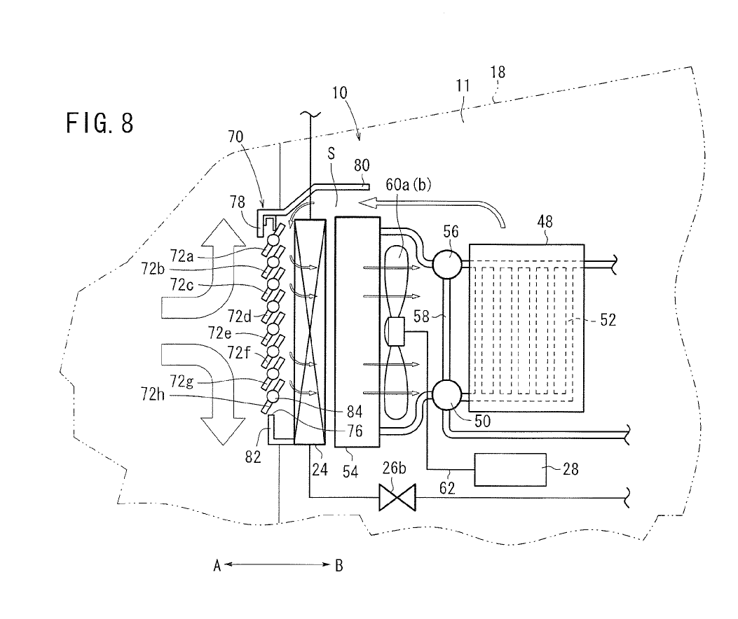

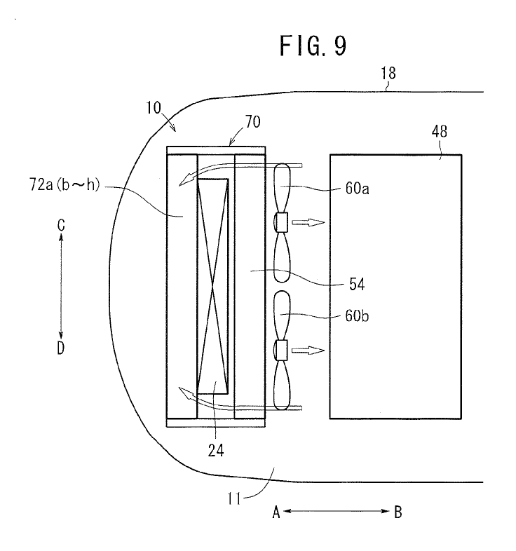

The displacement members 88 are disposed so as to be displaceable upwardly and downwardly (in the vertical direction) by driving units 90, which are connected to lower ends thereof. For example, in a heating mode region when the outside temperature is equal to or less than 10° C., as shown in FIGS. 7 and 8, based on a driving signal from the controller 28, the displacement members 88 are displaced downwardly to switch the shutters 72a to 72h to a closed state (CLOSE), whereas, in a cooling mode region when the outside temperature is greater than 10° C., as shown in FIGS. 3 and 6, the displacement members 88 are displaced upwardly to switch the shutters 72a to 72h into an opened state (OPEN). The driving units 90, for example, may comprise actuators having stepping motors, which are driven by supplying electricity thereto.

In the aforementioned cabin-exterior heat exchanger 24, a case has been explained in which the passage diameter D1 of the first port 42 and the passage diameter D2 of the second port 44 are set respectively at substantially constant diameters. However, the invention is not limited by this feature and, for example, when the first and second ports 42, 44 are connected by crimping or caulking with respect to non-illustrated pipes or the like, it is foreseen that the diameters D1 and D2 may become partially smaller at such areas. Stated otherwise, at such portions thereof, the first and second ports 42, 44 may be reduced in diameter in the radial direction thereof.

Generally, because an increase in pressure loss is caused at regions (smallest diameter regions) where the flow passage diameter through which the fluid flows is smallest, in the case described above, the passage diameters D1, D2 that cause pressure loss of the fluid are set at such regions, which are compressed radially inward and result in the minimum passage diameter of the passages.

Further, for example, in the case that the inner diameters of the pipes 46a, 46b, which are connected to the first and second ports 42, 44, are set smaller than the passage diameters D1, D2 of the first and second ports 42, 44, then with respect to the inner diameter of one pipe 46a that is connected to the first port 42, the inner diameter of the other pipe 46b, which is connected to the second port 44, may be formed so as to exceed roughly two times the inner diameter of the one pipe 46a.

The vehicular air conditioner 10 including a vehicle shutter device 74 according to the embodiment of the present invention is constructed basically as described above. Next, operations and advantages of the vehicular air conditioner 10 and the vehicle shutter device 74 shall be explained. First, operations shall be described when a heating operation is carried out in the vehicular air conditioner 10.

For example, in the case of a heating mode region when the temperature outside the vehicle 18 is equal to or less than 10° C., when the driver D (see FIG. 1) performs an action on an operating panel (not shown) of the vehicular air conditioner 10 and selects a heating drive mode, based on a drive signal from the controller 28, the driving units 90 are driven, whereupon the displacement members 88 are displaced upwardly by the driving units 90, and the shutters 72a to 72h are rotated into a closed condition (CLOSE), thereby blocking the duct 70 (see FIGS. 7 and 8).

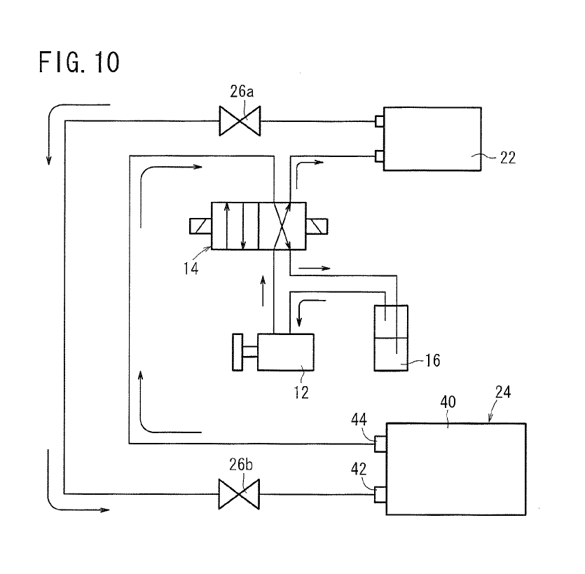

Further, accompanying an operation from the driver D, the dampers 38 are actuated, so that opened/closed states of the defroster outlet port 32, the face outlet port 34 and the foot outlet port 36 are set appropriately. In this manner, when the heating drive mode is selected, the four-way valve 14 is switched to the condition shown in FIG. 10, so that the coolant from the compressor 12 is supplied to the side of the cabin-interior heat exchanger 22.

Next, the cabin-interior fan 30 is driven rotatably, such that air inside the cabin of the vehicle 18 is supplied, via the cabin interior heat exchanger 22 and the heater core 64, to the selected defroster outlet port 32, the face outlet port 34, or the foot outlet port 36. Together therewith, because the shutters 72a to 72h are closed, the two cabin-exterior fans 60a, 60b arranged adjacent to the radiator 54 are driven rotatably in a positive direction of rotation (i.e., a direction such that air from the exterior is drawn into the vehicle).

In this case, as a result of the cabin-exterior fans 60a, 60b being driven in a positive direction of rotation, air on the side of the engine 48, after flowing toward the forward side (in the direction of the arrow A) of the vehicle 18 while passing through the gap S between the cover 80 of the duct 70 and both the radiator 54 and the cabin exterior heat exchanger 24, is drawn in toward the side of the engine 48 from the inner side of the shutters 72a to 72h, which are in a closed condition (CLOSE), via the cabin-exterior heat exchanger 24 and the radiator 54.

Upon completion of the aforementioned preparatory operations, the compressor 12 is driven and the heating drive mode is initiated.

Consequently, the coolant that is discharged from the compressor 12 is supplied via the four-way valve 14 to the cabin interior heat exchanger 22, whereupon the coolant undergoes condensation. At this time, under a driving action of the cabin-exterior fans 60a, 60b, air (warm air) that has been heated by heat generated from the engine 48 flows to the forward side of the vehicle 18 (in the direction of the arrow A) passing through the gap S between the cover 80 of the duct 70 and both the radiator 54 and the cabin exterior heat exchanger 24. In addition, after flowing between the shutters 72a to 72h, which are in a closed condition, and the cabin-exterior heat exchanger 24, the air is drawn in while passing over surfaces of the cabin-exterior heat exchanger 24 and the radiator 54, whereupon heat exchange is carried out, and the air passes through the radiator 54 and is taken in toward the side of the engine 48.

Additionally, the air having undergone heat exchange is supplied by the cabin-interior fan 30 to the cabin-interior heat exchanger 22, and after being raised in temperature at the cabin-interior heat exchanger 22, passes through the heater core 64 and is supplied into the vehicle cabin from the selected defroster outlet port 32, the face outlet port 34, or the foot outlet port 36.

Further, the water pump 50 supplies cooling water, which has been heated by the engine 48, from the water jacket 52 to the heater core 64 through the water valve 66. Accordingly, heated air (warm air), which is supplied to the cabin-interior heat exchanger 22 by the cabin-interior fan 30, is further heated by passing through the heater core 64, and then is supplied into the cabin interior.

Next, operations shall be described when a cooling operation is carried out in the vehicular air conditioner 10.

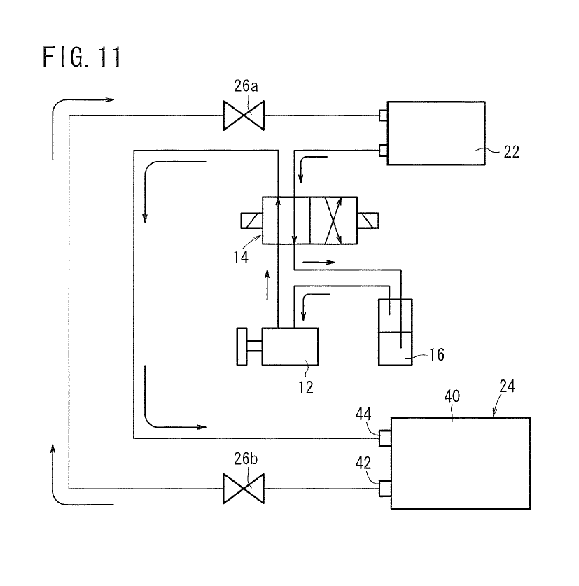

For example, in the case of a cooling mode region, when the temperature outside the vehicle 18 is of a generally high temperature, the shutters 72a to 72h are set to place the duct 70 in an open condition. More specifically, the driving units 90 are driven, whereupon the shutters 72a to 72h are rotated about the support shafts 84 and the duct 70 is opened. Next, when the driver D (see FIG. 1) performs an action on an operating panel (not shown) of the vehicular air conditioner 10 and selects a cooling drive mode, based on a drive signal from the controller 28, the driving units 90 are driven, whereupon the displacement members 88 are displaced downward by the driving units 90, and the shutters 72a to 72h are rotated into an opened condition (OPEN), thereby opening the duct 70 (see FIGS. 3 and 6). Further, simultaneously, the dampers 38 are actuated, so that opened/closed states of the defroster outlet port 32, the face outlet port 34 and the foot outlet port 36 are set appropriately. Together therewith, the four-way valve 14 is switched to the condition shown in FIG. 11, so that the coolant discharged from the compressor 12 is supplied to the side of the cabin-exterior heat exchanger 24. Further, the water valve 66 is closed, so that supply of cooling water to the heater core 64 is stopped.

In this case, as shown in FIGS. 3 and 6, the shutters 72a to 72h are placed in a substantially horizontal condition through the support shafts 84, and one end of the uppermost shutter 72a abuts against the upper end wall 78 of the duct 70, whereas the other end portions of the shutters 72a to 72h are arranged in close proximity to the side surface of the cabin-exterior heat exchanger 24, which is disposed rearwardly of the shutters 72a to 72h.

Next, the cabin-interior fan 30 is driven so as to supply external air into the cabin through the cabin-interior heat exchanger 22, while the cabin-exterior fans 60a, 60b are driven in a positive direction in order to take in external air and cool the cabin-exterior heat exchanger 24 and the radiator 54.

As a result of these actions, by means of the cabin-exterior fans 60a, 60b, which are rotated in a positive direction, air on the side of the engine 48 flows toward the forward side of the vehicle 18 (in the direction of the arrow A) while passing through the gap S between the cover 80 of the duct 70 and both the radiator 54 and the cabin-exterior heat exchanger 24. At this time, the shutters 72a to 72h are opened (OPEN) and in a horizontal condition, and in addition, the one end portion of the uppermost shutter 72a abuts against and seals the upper end wall 78 of the duct 70. Furthermore, because the other ends of the shutters 72a to 72h are arranged in close proximity to the side surface of the cabin-exterior heat exchanger 24, heated air is prevented from flowing to the forward side (in the direction of the arrow A) of the vehicle 18 while passing between the upper end wall 78 of the duct 70 and the shutters 72a to 72h. Additionally, air is prevented from passing between the shutters 72a to 72h and the cabin-exterior heat exchanger 24 and flowing in a downward direction. Owing thereto, air (warm air) that is heated by the engine 48 does not pass through the cabin-exterior heat exchanger 24 and is not drawn into the cabin interior.

Upon completion of the aforementioned preparatory operations, the coolant, which is compressed and discharged from the compressor 12, is directed via the four-way valve 14 to the second port 44 of the cabin-exterior heat exchanger 24, is evaporated in the main body 40 of the cabin-exterior heat exchanger 24, and further is cooled by external air that is taken in by the cabin-exterior fans 60a, 60b.

Subsequently, the coolant is supplied to the first solenoid valve 26a via the second solenoid valve 26b, and after being nebulized, and as a result of being evaporated in the cabin-interior heat exchanger 22, the exterior air supplied from the cabin-interior fan 30 is chilled and cools the interior of the vehicle cabin. After the evaporated coolant is supplied from the four-way valve 14 to the accumulator 16, the gaseous part of the coolant is sucked in by the compressor 12, and the cooling operation (refrigeration cycle) is continued.

In the forgoing manner, in the present embodiment, as a result of forming the cover 80 at an upper portion of the duct 70, which extends toward the rearward side (the direction of the arrow B) of the vehicle 18 while covering at least the upper portion of the cabin-exterior heat exchanger 24, when the shutters 72a to 72h are closed and a heating operation is carried out, air (warm air), the temperature of which is raised by heat generated from the engine 48, passes through the gap S between the cover 80 and the cabin-exterior heat exchanger 24, and can be guided suitably toward the forward side (in the direction of the arrow A) of the vehicle 18. Owing thereto, by rotation of the cabin-exterior fans 60a, 60b, heated air (warm air) can be drawn in from the upper side of the shutters 72a to 72h while passing over the entire surface of the cabin-exterior heat exchanger 24, and heat exchange can be performed efficiently.

As a result, in the cabin-exterior heat exchanger 24, heat can be recovered efficiently from air (warm air) that has been heated by heat from the engine 48, and along therewith, the heating capability in the vehicular air conditioner 10 can be improved, and the comfort of passengers in the vehicle cabin can be enhanced.

Further, during a cooling operation when the shutters 72a to 72h are opened and air external to the vehicle 18 is capable of being introduced into the engine room 11, because the other ends of the shutters 72a to 72h are positioned in close proximity to the side surface of the cabin-exterior heat exchanger 24, when air (warm air) that has been raised in temperature from the heat generated by the engine 48 flows toward the forward side of the vehicle 18 (in the direction of the arrow A) passing through the upper portion of the duct 70, flow of such air between the shutters 72a to 72h and the cabin-exterior heat exchanger 24 is stopped. As a result, heated air (warm air) is prevented from being drawn into the cabin-exterior heat exchanger 24, and during the cooling operation, deterioration in the cooling capability caused by such heated air (warm air) being supplied to the cabin-exterior heat exchanger 24 can be prevented. In addition, a desired cooling capability can be brought about as a result of external air passing through the opened shutters 72a to 72h and being taken in from the forward end of the vehicle 18, thereby enhancing the comfort of vehicle passengers.

Stated otherwise, since the heated air (warm air) that flows through the gap S disposed above the cabin-exterior heat exchanger 24 is prevented, by the uppermost shutter 72a, from wrapping around and flowing back toward the forward side (in the direction of the arrow A) of the cabin-exterior heat exchanger 24, deterioration of cooling efficiency, which would be of concern if such air were taken in, can be avoided.

Furthermore, because lowering of the intake pressure in the compressor 12 can be prevented, deterioration in the durability of the compressor 12 caused by a decline in the intake pressure thereof can also be prevented.

The aforementioned cover 80 that makes up the duct 70 is not limited to a case of extending over the upper portion of the radiator 54. For example, the cover 80 may also extend to a position covering a portion of the engine 48, which is disposed more rearwardly than the radiator 54. In this case, as a result of the cover 80 that extends to the vicinity of the engine 48, air that is heated by heat generated at the engine 48 can be guided appropriately to the forward side of the vehicle 18, thus enabling heat exchange to be performed more efficiently by the cabin-exterior heat exchanger 24. Owing thereto, the heating capability of the vehicular air conditioner 10 can be enhanced.

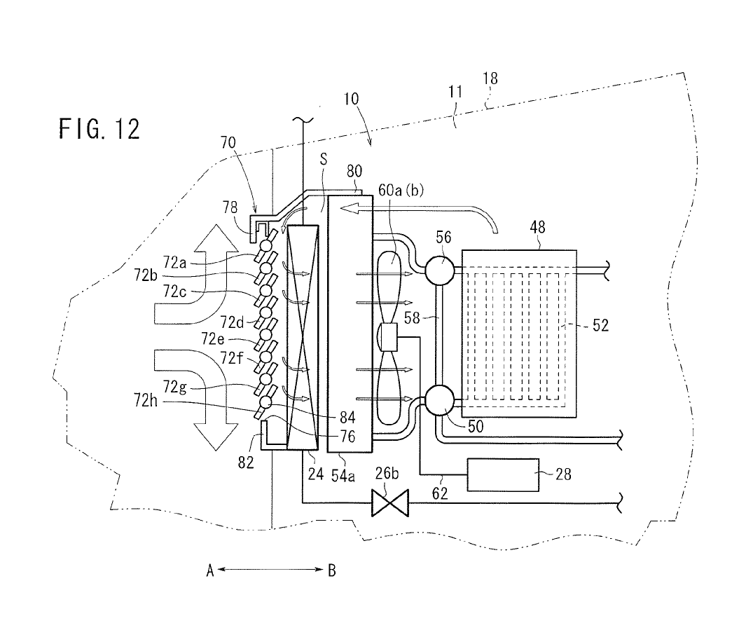

Further, as in the first modified example shown in FIG. 12, by setting the height of the upper portion of the radiator 54a at the same height as the upper portion of the duct 70, because air that flows along the upper portion of the duct 70 upon driving of the cabin-exterior fans 60a, 60b is made to flow through the radiator 54a toward the forward side of the vehicle 18 (in the direction of the arrow A), such air is cable of recovering heat generated by the engine 48 added together with heat in the radiator 54a, so that air (warm air) more greatly elevated in temperature can be blown into the cabin interior via the cabin-interior fan 30. That is, the heating capability of the vehicular air conditioner 10 can be further improved, and the comfort of passengers in the vehicle cabin can be enhanced.

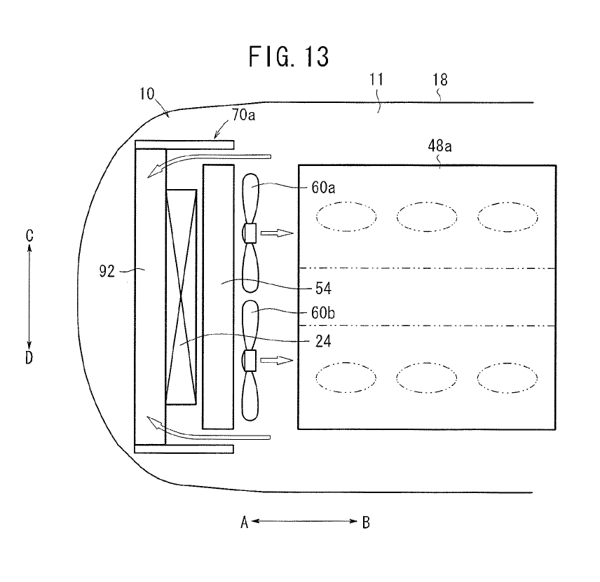

Furthermore, as in the second modified example shown in FIG. 13, the widthwise dimension of the shutters 92 may be widened, such that opposite ends thereof project at a fixed width in the lateral direction (the direction of arrows C and D) with respect to opposite end portions of the cabin-exterior heat exchanger 24 and the radiator 54. In this case, corresponding to widening of the shutters 92, the widthwise dimension of the duct 70a also is widened.

Owing thereto, for example, even if a V-type engine 48a providing a heat source in a lateral direction which lies in the widthwise direction of the vehicle 18 is mounted lengthwise in the vehicle 18, when air (warm air) that has been raised in temperature by heat generated respectively on left and right sides with respect to the center of the engine room 11 is made to flow toward the forward side (in the direction of the arrow A) of the vehicle 18, such air can be collected efficiently by the widened duct 70a and guided to the forward side of the vehicle 18.

More specifically, heat that is generated at left and right sides (i.e., in the widthwise direction) of the engine room 11 in the vehicle 18 can be suitably recovered, and by making use of such heated air (warm air), the heating capability of the vehicular air conditioner 10 can be improved.

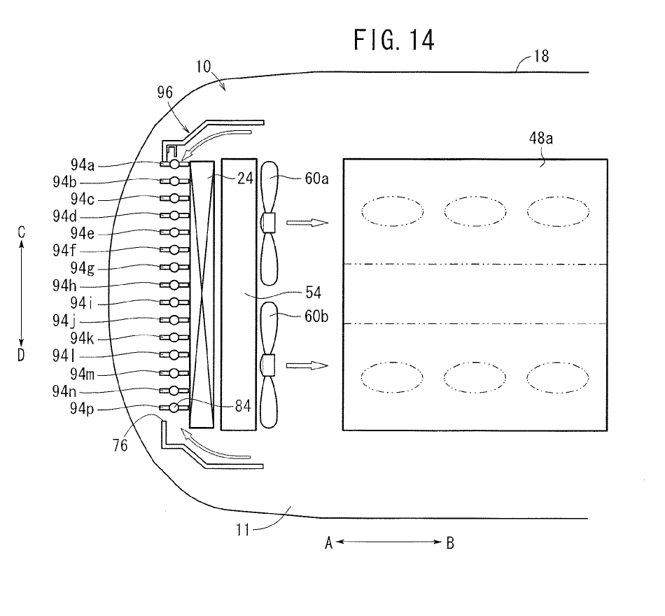

Further, in the vehicular air conditioner 10 shown in FIG. 1, the plurality of support shafts 84 and shutters 72a to 72h, which are disposed horizontally, may, as in the third modified example shown in FIG. 14, be arranged perpendicularly thereto so as to extend in a vertical direction, the shutters 72a to 72h being supported rotatably with respect to the duct 70.

By adopting such a structure, as shown in FIG. 14, in a vehicle having the aforementioned V-type engine 48a mounted therein, when a cooling operation is carried out, the shutters (openable/closable doors) 94a to 94p are rotated into an opened state under a driving action of the driving units 90. At this time, one end of the shutter 94a, which is disposed at the most outside position, abuts against an end surface of the opening 76 in the duct 96, while other ends of the shutters 94a to 94p are positioned in close proximity to a side surface of the cabin-exterior heat exchanger 24. In addition, heated air (warm air) flowing toward the front side of the vehicle 18 (in the direction of the arrow A) from left and right sides of the V-type engine 48a can be stopped and prevented, by the opened shutters 94a to 94p, from being supplied to the side of the cabin-exterior heat exchanger 24. Accordingly, even in the case of a heat source in left and right directions, such as the V-type engine 48a, in the engine room 11, during the cooling operation, supply of heated air (warm air) to the cabin-exterior heat exchanger 24 can be avoided, and a deterioration in the cooling capability due to supplying such heated air to the cabin-exterior heat exchanger 24 can be prevented.

Stated otherwise, since wrapping around of the heated air (warm air) from left and right directions with respect to the cabin-exterior heat exchanger 24, and such heated air being drawn into the cabin-exterior heat exchanger 24 can be prevented, deterioration of the cooling capability can be avoided.

Further, for example, when a heating operation is performed, the first port 42 through which the coolant is introduced in to the main body 40, and the second port 44 through which the coolant having been introduced from the first port 42 and passed through the interior of the main body 40 is discharged to the exterior, are both disposed on the same side surface of the main body 40 that makes up the cabin-exterior heat exchanger 24. Further, concerning the first and second ports 42, 44, which are tubular shaped, the passage diameter (interior diameter) D2 of the second port 44 is set within a range that exceeds roughly two times, and is equal to or less than roughly 2.8 times, the passage diameter (interior diameter) D1 of the first port 42.

Generally speaking, in a conventional heat exchanger used in a vehicular air conditioner 10 equipped with both cooling and heating functions, the passage diameters D1, D2 of the first and second ports 42, 44 are set considering only the cooling operation of the vehicular air conditioner, and the ratio of the passage diameter D1 of the first port 42 to the passage diameter D2 of the second port 44 is set at 1 to 1.5 (1:1.5). In this case, although problems do not occur during the cooling operation, during the heating operation, pressure losses on the side of the second port 44 through which the coolant is discharged become large, and because lowering of the flow rate of the coolant caused by the increase in pressure loss occurs, the heating capability tends to be deteriorated, and there is a concern that the durability of the compressor 12 will suffer accompanying a decline in the flow rate of the coolant.

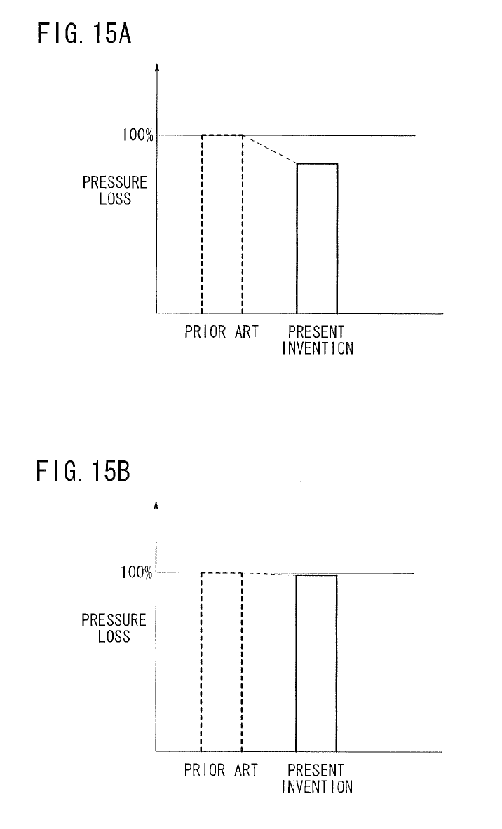

In contrast thereto, with the present invention, the ratio of the passage diameter D2 of the second port 44 with respect to the passage diameter D1 of the first port 42 to which the coolant is introduced during a heating operation is set large, whereby the heating capability during the heating mode can be improved, together with reducing pressure losses (see FIG. 15A). Further, lowering of the coolant flow rate, which is feared when pressure losses occur, can be avoided, and a decline in durability of the compressor 12 can be prevented.

Further, even during cooling operations, the cooling capability can be maintained while pressure losses of the coolant can be decreased slightly (see FIG. 15B).

More specifically, in the cabin-exterior heat exchanger 24, by setting the passage diameter D2 of the second port 44 to exceed roughly two times, and to be equal to or less than 2.8 times, the passage diameter D1 of the first port 42, the heating capability during heating operations can be increased along with decreasing pressure losses, and in addition, pressure losses during cooling operations can also be decreased slightly.

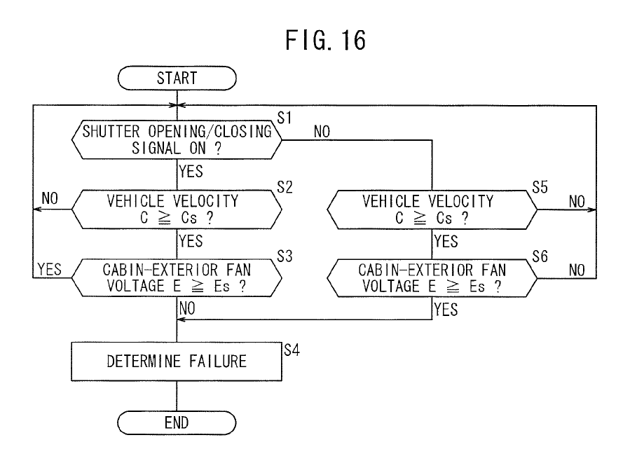

Next, in accordance with the flowchart shown in FIG. 16, explanations shall be given of a case of carrying out failure determination of the vehicle shutter device 74.

First, based on drive signals imposed with respect to the driving units 90, the opened or closed condition of the shutters 72a to 72h in the vehicle shutter device 74 is confirmed (step S1). More specifically, in the case that drive signals are imposed with respect to the driving units 90 to cause the displacement members 88 to be displaced in a downward direction, the shutters 72a to 72h are in an opened state (OPEN), while conversely, in the case that drive signals are imposed with respect to the driving units 90 to cause the displacement members 88 to be displaced in an upward direction, the shutters 72a to 72h are in a closed state (CLOSE).

Additionally, if the shutters 72a to 72h are in an opened condition, in step S2, it is determined whether or not the vehicle velocity C of the vehicle 18 is equal to or greater than a predetermined velocity Cs (e.g. 50 km/h), which has been set beforehand. The vehicle velocity C is confirmed, for example, based on a velocity signal that is output to the controller 28 from a velocity sensor mounted in the vehicle 18. On the other hand, if it is confirmed that the shutters 72a to 72h are in a closed condition, the sequence proceeds directly to step S5 (described later) without going through step S2.

In this case, because the shutters 72a to 72h are in an opened condition, running wind (air) is introduced into the engine room 11 through the vehicle shutter device 74 from the forward side of the vehicle 18. The running wind impinges upon the cabin-exterior fans 60a, 60b, whereupon the cabin-exterior fans 60a, 60b are made to rotate at a given rotational speed (RPM) by means of the running wind.

The aforementioned predetermined velocity Cs is set to a velocity that generates a predetermined voltage (e.g., about 1 volt) from the rotating cabin-exterior fans 60a, 60b, the cabin-exterior fans 60a, 60b being forcibly rotated during running of the vehicle 18 by means of the running wind, which is introduced into the engine room 11 from the front side of the vehicle 18.

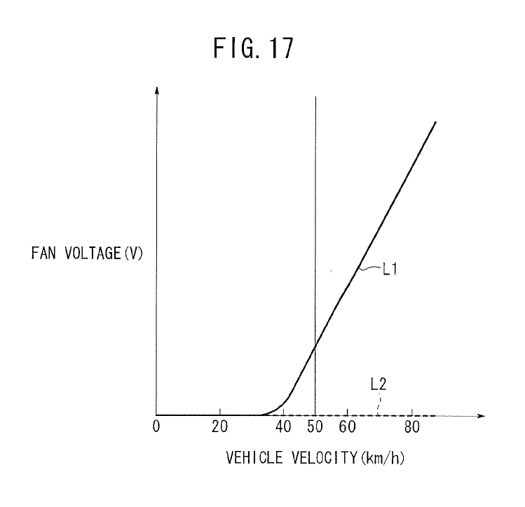

Based on the relationship shown in FIG. 17 between vehicle velocity C and the voltage E generated by the cabin-exterior fans 60a, 60b, a case shall briefly be explained concerning setting of the predetermined velocity Cs. The solid line in FIG. 17 is a characteristic curve L1 indicative of a relationship between vehicle velocity C and the voltage E generated by the cabin-exterior fans 60a, 60b in a case when the shutters 72a to 72h in the vehicle shutter device 74 are opened (OPEN). The broken line is a characteristic curve L2 indicative of a relationship between vehicle velocity C and the voltage E generated by the cabin-exterior fans 60a, 60b in a case when the shutters 72a to 72h are closed (CLOSE).

As shown in FIG. 17, for example, at a point around where the vehicle velocity C of the vehicle 18 reaches about 40 km/h, the cabin-exterior fans 60a, 60b begin to be rotated by the running wind that impinges upon the cabin-exterior fans 60a, 60b, and accompanying such rotation, a voltage E starts to be generated. Additionally, at a point where the vehicle velocity C reaches about 50 km/h, compared to the point at about 40 km/h, it can be understood that the voltage E increases further and reaches the predetermined value. Owing thereto, in this case, roughly 50 km/h at which the predetermined voltage E (e.g., 1V) is obtained, is set as the predetermined velocity Cs. Moreover, in the case that the shutters 72a to 72h are closed, as understood from the broken line L2 in FIG. 17, since running wind does not impinge upon the cabin-exterior fans 60a, 60b, and the cabin-exterior fans 60a, 60b are not rotated, no voltage E whatsoever is generated.

Additionally, in the flowchart of FIG. 16, in the case that the vehicle velocity C of the vehicle 18 is greater than or equal to the predetermined velocity Cs (C≧Cs), then the sequence progresses to step S3, at which the voltage E generated by the rotating cabin-exterior fans 60a, 60b is output to the controller 28 via the lead lines 62, and the voltage value thereof is detected in the controller 28. In the controller 28, the generated voltage E is compared with a predetermined voltage Es set beforehand, and a determination is made as to whether or not the voltage E is greater than or equal to the predetermined voltage Es (step S3). The predetermined voltage Es is set at a size (e.g., about 1V) at which generation of the voltage E in the cabin-exterior fans 60a, 60b can clearly be confirmed.

In addition, in the case that the voltage E of the cabin-exterior fans 60a, 60b is smaller than the predetermined voltage Es (E<Es), it is judged that the cabin-exterior fans 60a, 60b are not rotating despite the fact that the shutters 72a to 72h should be in an opened condition (OPEN). More specifically, it is assumed that the cabin-exterior fans 60a, 60b are not rotating because, for some reason, the shutters 72a to 72h are closed and not opened, and hence running wind is not being introduced into the engine room 11.

Consequently, it is judged that a failure condition has occurred in the vehicle shutter device 74, whereupon, for example, a warning signal is output from the controller 28 to a non-illustrated warning lamp or the like inside the vehicle compartment, thereby causing the warning lamp or the like to become illuminated and display the failure state (step S4).

Further, in step S3, in the case that the voltage E at the cabin-exterior fans 60a, 60b is greater than or equal to the predetermined voltage Es (E≧Es), since it is confirmed that the shutters 72a to 72h are opened to the preset opening degree, and that running wind is being introduced into the engine room 11 at a desired flow rate whereby the cabin-exterior fans 60a, 60b are rotated by the running wind, it is understood that the vehicle shutter device 74 is in an opened condition and is being driven normally. Thus, the sequence returns again to step S1, and failure determination of the vehicle shutter device 74 continues to be carried out in succession.

On the other hand, in step S1, in the event it is confirmed that the shutters 72a to 72h are in a closed state (CLOSE) based on the driving signal output from the controller 28 with respect to the driving units 90, then in the controller 28, it is determined whether or not the vehicle velocity C of the vehicle 18 is greater than or equal to the predetermined velocity Cs (e.g., 50 km/h) set beforehand (step S5). When the shutters 72a to 72h are in a closed condition, running wind (air) is not introduced into the engine room 11 from the exterior of the vehicle 18, and thus such running wind does not impinge upon the cabin-exterior fans 60a, 60b and does not forcibly cause the cabin-exterior fans 60a, 60b to rotate.

Next, in step S5, if the vehicle velocity C of the vehicle 18 is greater than or equal to the predetermined velocity Cs set beforehand (C≧Cs), then the voltage E generated by the cabin-exterior fans 60a, 60b is detected and is output as an output signal to the controller 28, and in the controller 28 a comparison is performed with the predetermined voltage Es (step S6). In step S5, in the case that the vehicle velocity C of the vehicle 18 is less than the predetermined velocity Cs set beforehand (C<Cs), the sequence returns to step S1, and determination of the opened/closed state of the shutters 72a to 72h is carried out again.

In addition, in step S6, if the fan voltage E is greater than or equal to the predetermined voltage Es (E≧Es) although the shutters 72a to 72h are indicated to be in a closed condition (CLOSE), it is determined that the cabin-exterior fans 60a, 60b are in a rotating state (step S4). More specifically, it is assumed that, due to some reason, the shutters 72a to 72h have experienced a failure and are in an opened state (OPEN) without properly closing.

Consequently, it is judged that a failure condition has occurred in the vehicle shutter device 74, whereupon, for example, a warning signal is output from the controller 28 to a non-illustrated warning lamp or the like inside the vehicle compartment, thereby causing the warning lamp or the like to become illuminated and display the failure state (step S4).

Further, in the case that the voltage E at the cabin-exterior fans 60a, 60b is less than the predetermined voltage Es (E<Es), it is understood that the vehicle shutters 72a to 72h have reliably closed, that running wind is not impinging upon the cabin-exterior fans 60a, 60b and the fans are in a non-rotating state. Additionally, while the vehicle 18 continues running, the sequence returns again to step S1, and failure determination of the vehicle shutter device 74 continues to be carried out in succession.

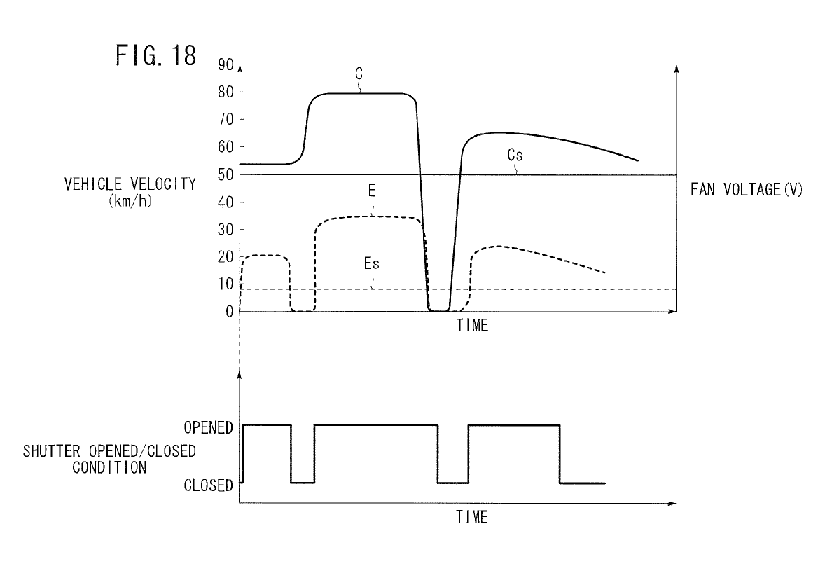

In the case that the vehicle shutter device 74 is not faulty and opening/closing operations thereon are performed properly, as understood from the characteristic curve diagram shown in FIG. 18, which shows relationships between the vehicle velocity C of the vehicle 18, the voltage E generated by the cabin-exterior fans 60a, 60b which are rotated by running wind, and opened and closed states of the shutters 72a to 72h, if the shutters 72a to 72h are in an opened condition (OPEN) and the vehicle velocity C is greater than or equal to the predetermined velocity Cs (C≧Cs), then the voltage E generated at the cabin-exterior fans 60a, 60b becomes equal to or greater than the predetermined voltage Es (E≧Es), whereas by closing the shutters 72a to 72h while the vehicle velocity C is maintained, the voltage E becomes less than the predetermined voltage Es (E<Es). Further, in the case that the vehicle velocity C is less than the predetermined velocity Cs (C<Cs) as well, the voltage E becomes less than the predetermined voltage Es (E<Es).

On the other hand, when a cooling operation is carried out, based on driving signals output from the controller 28 to the driving units 90, the displacement members 88 are displaced downwardly, and the plural shutters 72a to 72h are rotated about the support shafts 84 into a substantially horizontal condition. As a result thereof, the shutters 72a to 72h place the duct 70 in an opened state, and by putting the exterior of the vehicle 18 in communication with the engine room 11, running wind during running of the vehicle 18 is directed into the engine room 11. Since they have already been discussed above, detailed explanations concerning features that occur during the cooling operation have been omitted.

In this case as well, failure determination of the vehicle shutter device 74 is carried out according to the flowchart shown in FIG. 16.

In the foregoing manner, with the present embodiment, when the vehicle 18 is running, by detecting the voltage E generated by the cabin-exterior fans 60a, 60b, malfunctioning of the vehicle shutter device 74, which is capable of switching an introduction state of external air into the engine room 11, can easily and reliably be detected. More specifically, without separately providing a dedicated failure detection means for detecting malfunctions of the vehicle shutter device 74, and with a simple structure using only the cabin-exterior fans 60a, 60b, malfunctioning of the vehicle shutter device 74 during running of the vehicle 18 can be confirmed.

Stated otherwise, utilizing forced rotation of the cabin-exterior fans 60a, 60b, which is caused when running wind during running of the vehicle 18 impinges against the cabin-exterior fans 60a, 60b, malfunctioning of the vehicle shutter device 74 can easily be detected.

Further, for example, by placing the shutters 72a to 72h of the vehicle shutter device 74 in a closed condition (CLOSE), and supplying, into the cabin, air that has been heated using heat generated by the engine 48 inside the engine room 11, heating of the cabin interior is carried out. However, in this case, if the shutters 72a to 72h, as a result of the aforementioned malfunctioning, are placed in an opened state (OPEN), then a problem results in that the heat inside the engine room 11 escapes to the exterior, and the heating efficiency, particularly at times of low temperature, becomes deteriorated. In contrast thereto, in the present invention, since malfunctioning of the shutters 72a to 72h can reliably be detected from the voltage E generated by the cabin-exterior fans 60a, 60b, escape of heat from the engine room 11 at times of low temperature, can reliably be avoided. As a result, deterioration of the heating efficiency at times of low temperature can be prevented, and a desired heating capability can suitably be obtained.

Furthermore, for example, in the case that the shutters 72a to 72h are placed in a closed condition, whereby the cooling water temperature of the engine 48 inside the engine room 11 to which exterior air is not introduced becomes raised, lowering of the water temperature, which would be feared in the case that the shutters 72a to 72h were mistakenly placed in an opened state (OPEN), can be avoided, and the cooling water can efficiently be heated, and the temperature of the water can be raised.

Still further, for example, in a high load condition of the engine 48, during high speed running or acceleration, etc., of the vehicle 18, in the case that the amount of heat generated by the engine 48 is increased compared to normal running conditions, it is necessary for the shutters 72a to 72h to be placed in an opened condition (OPEN), for running wind to impinge against the radiator 54 to cool the engine 48, and for the temperature of the cooling liquid to be lowered. However, in such a high load condition, in the case that the shutters 72a to 72h malfunction and are mistakenly placed in a closed condition (CLOSE), the temperature of the cooling water is raised, and since the engine 48 cannot be cooled, a condition of overheating occurs, and it can be presumed that a trouble during running of the vehicle 18 may result. In the present invention, even in the case of such a high load condition, since malfunctioning of the vehicle shutter device 74 can reliably be detected from the voltage E generated by the cabin-exterior fans 60a, 60b, raising of the cooling water temperature due to failure of the vehicle shutter device 74, and the occurrence of overheating, etc., can reliably be prevented.

The vehicular air conditioner according to the present invention is not limited to the embodiments and examples described above. It is a matter of course that various modified or additional structures could be adopted without deviated from the essence and scope of the present invention as set forth in the appended claims.

What is claimed is:

1. A vehicular air conditioner comprising:
a compressor for drawing in and compressing a coolant;
a cabin-interior heat exchanger for condensing the compressed coolant;
a cabin-exterior heat exchanger for evaporating the coolant;
a blower fan for blowing air through the cabin-exterior heat exchanger;
a communication passage that communicates between the cabin-exterior heat exchanger and the exterior of a vehicle; and
a vehicle shutter device for switching a communication state of the communication passage according to an exterior temperature of the vehicle or a temperature of air inside an engine room of the vehicle,
wherein an openable/closable door of the vehicle shutter device that opens and closes the communication passage is disposed in the engine room at a forward side in the vehicle, and the cabin-exterior heat exchanger is disposed between the openable/closable door and an engine which is located at a rearward side, the communication passage extending from the openable/closable door up to a position that covers at least the cabin-exterior heat exchanger.

2. The vehicular air conditioner according to claim 1, wherein the openable/closable door is adjacent to the cabin-exterior heat exchanger in an opened condition in which air external to the vehicle is introduced to the interior of the engine room.

3. The vehicular air conditioner according to claim 2, wherein, in the opened condition, the openable/closable door abuts against an opening of the communication passage and blocks communication with a gap that is disposed between the communication passage and the cabin-exterior heat exchanger.

4. The vehicular air conditioner according to claim 1, wherein a radiator is disposed in the engine room between the cabin-exterior heat exchanger and the engine, and the radiator abuts against an inner wall surface of the communication passage.

5. The vehicular air conditioner according to claim 1, wherein the openable/closable door comprises a plurality of openable/closable doors disposed along a widthwise direction of the vehicle and which are rotatably disposed via respective support shafts.

6. The vehicular air conditioner according to claim 1, wherein the openable/closable door comprises a plurality of openable/closable doors disposed along a height direction of the vehicle and which are rotatably disposed via respective support shafts.

7. The vehicular air conditioner according to claim 1, wherein the cabin-exterior heat exchanger further comprises:
a housing;
a first passage disposed on a side portion of the housing and to which the coolant is supplied during a heating operation; and
a second passage disposed on the side portion of the housing the same as the first passage and which discharges the coolant after having been circulated inside the housing, to the exterior during the heating operation,
wherein an inner diameter of the second passage is set so as to exceed roughly two times an inner diameter of the first passage.

8. The vehicular air conditioner according to claim 7, wherein the inner diameter of the second passage is set less than roughly 2.8 times the inner diameter of the first passage.

9. The vehicular air conditioner according to claim 8, wherein the inner diameter of the first passage is set at 5 mm, whereas the inner diameter of the second passage is set within a range exceeding 10 mm and less than or equal to 14 mM.

10. The vehicular air conditioner according to claim 7, wherein the first passage comprises a first port or pipe that is formed on the side portion of the housing, and the second passage comprises a second port or pipe that is formed on the side portion of the housing.

11. The vehicular air conditioner according to claim 1, wherein the vehicle shutter device further comprises:
detecting means capable of detecting an opened or closed state of the openable/closable door during running of the vehicle; and
failure determining means for performing failure determination of the openable/closable door based on a detection result by the detecting means,
wherein the detecting means detects the opened or closed state of the openable/closable door based on a voltage change when the blower fan is rotated by running wind that is introduced from the exterior during running of the vehicle.

12. The vehicular air conditioner according to claim 11, wherein the openable/closable door opens and closes the communication passage corresponding to a cooling water temperature of the engine in the vehicle, or corresponding to an operational state of the vehicular air conditioner.

13. The vehicular air conditioner according to claim 11, wherein the failure determining means carries out failure determination of the openable/closable door based on a velocity of the vehicle during a running state thereof, a voltage change generated by the blower fan, and an opened/closed state of the openable/closable door.

14. A failure determining method for a vehicle shutter device in an engine room of a vehicle, which switches a communication state of a communication passage that communicates between the exterior of the vehicle and the engine room, for carrying out failure determination of an openable/closable door that opens and closes the communication passage corresponding to a cooling water temperature of an engine in the vehicle, or corresponding to an operational state of a vehicular air conditioner disposed in the engine room, the method comprising the steps of:
confirming an opened or closed state of the openable/closable door during running of the vehicle;
judging whether or not a velocity of the vehicle is greater than or equal to a predetermined velocity set beforehand;
in the case that the velocity of the vehicle is greater than or equal to the predetermined velocity, detecting a voltage generated by a blower fan that constitutes part of the vehicular air conditioner, and determining whether or not the voltage is greater than or equal to a predetermined voltage set beforehand; and
in the case that the openable/closable door is in an opened state, the vehicle velocity is greater than or equal to the predetermined velocity, and the voltage is lower than the predetermined voltage, or in the case that the openable/closable door is in a closed state, the vehicle velocity is greater than or equal to the predetermined velocity, and the voltage is greater than or equal to the predetermined voltage, determining that the openable/closable door is malfunctioning and is not in a desired open or closed condition.

15. The failure determining method for a vehicle shutter device according to claim 14, wherein the predetermined velocity is set at approximately 50 km/h.

16. The failure determining method for a vehicle shutter device according to claim 14, wherein the predetermined voltage is set at approximately 1 V.
